(19) United States
(12) Patent Application Publication
(10) Pub. No.: US 2024/0150155 A1
(43) Pub. Date: May 9, 2024

(54) KNUCKLE BOOM CRANE

(71) Applicant: Sarens Nuclear & Industrial Services LLC, Hartford, WI (US)

(72) Inventors: Katherine Coleman, Hartford, WI (US); Stuart Oliphant, Hartford, WI (US); Patrick Quaglieri, Hartford, WI (US); Joseph Yustus, Hartford, WI (US); Bogdan Gaita, Indian Land, SC (US)

(21) Appl. No.: 18/504,912

(22) Filed: Nov. 8, 2023

Related U.S. Application Data
(60) Provisional application No. 63/423,730, filed on Nov. 8, 2022.

(51) Int. Cl. B66C 23/72; B66C 23/70

(52) U.S. Cl. CPC B66C 23/72; B66C 23/701

(57) ABSTRACT

A knuckle boom crane includes a base with a top surface and a bottom surface, a slewing platform fixedly coupled to the top surface, a slew column rotatably coupled to the slewing platform, a counterweight coupled to the slew column and configured to pivot with the slew column, an intermediate boom pivotably coupled to the slew column, and a telescoping outer boom pivotably coupled to the intermediate boom. The knuckle boom crane further includes a plurality of outriggers pivotably coupled to the top surface between a stored position and a supporting position, a robotic driving unit rotatably coupled to the bottom surface and configured to drive the knuckle boom crane, and a plurality of base lifts coupled to the bottom surface and adjustable between a retracted and an extended position.

### CROSS-REFERENCE TO RELATED APPLICATIONS

This application claims priority to U.S. Provisional Patent Application No. 63/423,730, filed Nov. 8, 2022, the entire contents of which is incorporated herein by reference.

### FIELD OF INVENTION

Exemplary embodiments relate to the art of cranes, and more particularly, to a compact knuckle boom crane.

### SUMMARY

In one aspect, the disclosure provides a knuckle boom crane including a base with a top surface and a bottom surface, a slewing platform fixedly coupled to the top surface, a slew column rotatably coupled to the slewing platform, a counterweight coupled to the slew column and configured to pivot with the slew column, an intermediate boom pivotably coupled to the slew column, and a telescoping outer boom pivotably coupled to the intermediate boom. The knuckle boom crane further includes a plurality of outriggers pivotably coupled to the top surface between a stored position and a supporting position, a robotic driving unit rotatably coupled to the bottom surface and configured to drive the knuckle boom crane, and a plurality of base lifts coupled to the bottom surface and adjustable between a retracted and an extended position.

In another aspect, the disclosure provides a knuckle boom crane including a base with a top surface and a bottom surface, a slew column rotatably coupled to the base, a telescoping boom pivotably coupled to the slew column, a plurality of outriggers coupled to the top surface of the base, and a robotic driving unit rotatably coupled to the bottom surface of the base. The robotic driving unit is connected to a controller. The controller is configured to control operation of the robotic driving unit to drive the knuckle boom crane.

Other aspects and embodiments will become apparent by consideration of the detailed description and accompanying drawings.

### BRIEF DESCRIPTION OF THE DRAWINGS

FIG. 1 is a top perspective view of a knuckle boom crane.

FIG. 2 is a side view of the knuckle boom crane of FIG. 1.

FIG. 3 is an additional perspective view of the knuckle boom crane of FIG. 1.

FIG. 4 is an additional perspective view of the knuckle boom crane of FIG. 1.

FIG. 5 is a cross-sectional view of portion 5-5 of the knuckle boom crane of FIG. 1.

FIG. 6 is a perspective view of an outrigger of the knuckle boom crane of FIG. 1.

FIG. 7 is a perspective view of the knuckle boom crane of FIG. 1 with outriggers in a supporting position.

FIG. 8 is a bottom perspective view of the knuckle boom crane of FIG. 1.

FIG. 9 is an enlarged view of base lifts of the knuckle boom crane of FIG. 1.

FIG. 10 is an additional enlarged view of the base lifts of FIG. 9.

FIG. 11 is an enlarged view of controlling components of the knuckle boom crane of FIG. 1.

FIG. 12 is a perspective view of the knuckle boom crane of FIG. 1 with telescoping sections extended.

FIG. 13 is an additional perspective view of the knuckle boom crane of FIG. 1 with telescoping sections extended.

### DETAILED DESCRIPTION

Before any embodiments are explained in detail, it is to be understood that the disclosure is not intended to be limited in its application to the details of construction and the arrangement of components set forth in the following description or illustrated in the following drawings. Embodiments are capable of other configurations and of being practiced or of being carried out in various ways.

Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items.

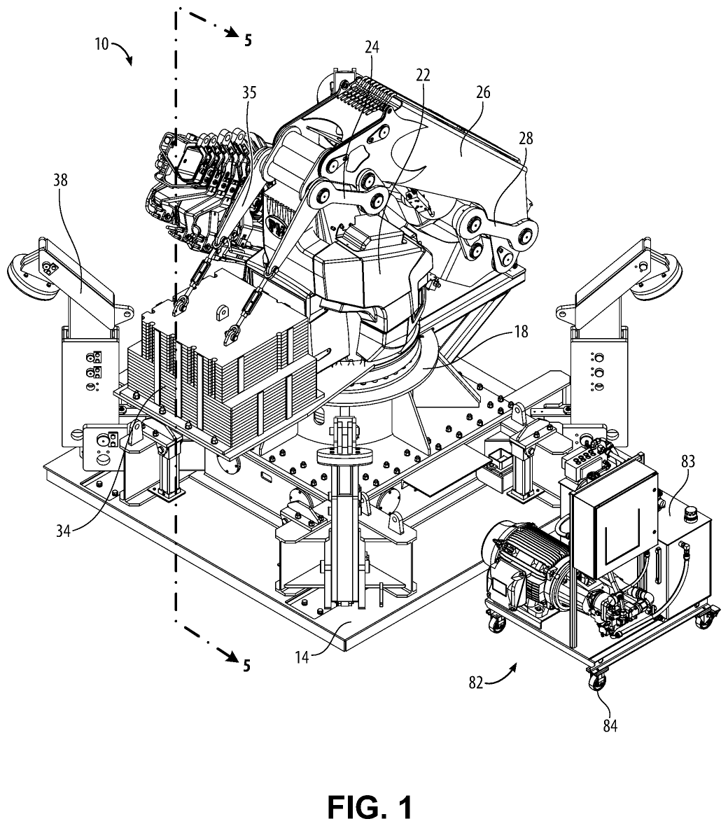

Referring now to the figures, FIGS. 1-4 depict an embodiment of a knuckle boom crane 10. The knuckle boom crane 10 includes a base 14, a slewing platform 18 fixedly coupled to the base 14, a slew column 22 rotatably coupled to the slewing platform 18, an intermediate boom 26 pivotably coupled to the slew column 22, and a telescoping outer boom 30 pivotably coupled to the intermediate boom 26. A counterweight 34 is cantilevered off the slew column 22. The counterweight 34 is configured to provide a moment to offset a load lifted by the knuckle boom crane 10. The knuckle boom crane 10 is stabilized and further supported by a plurality of outriggers 38 coupled to the base 14. The illustrated embodiment includes one of the outriggers 38 coupled to each corner of the base 14 (e.g., in a spider crane arrangement). In some embodiments, the outriggers 38 may be disposed along sides of the base 14.

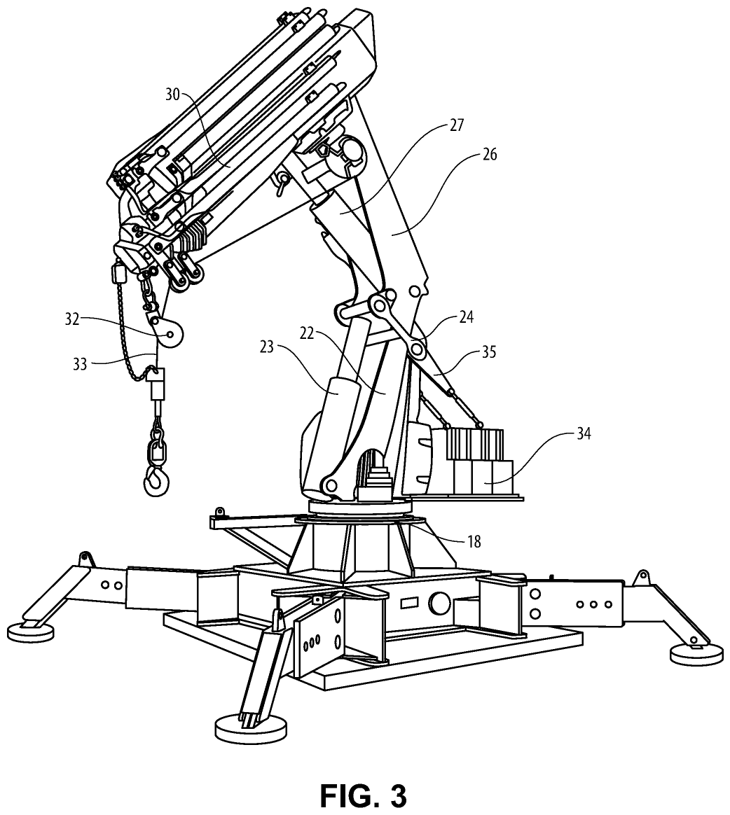

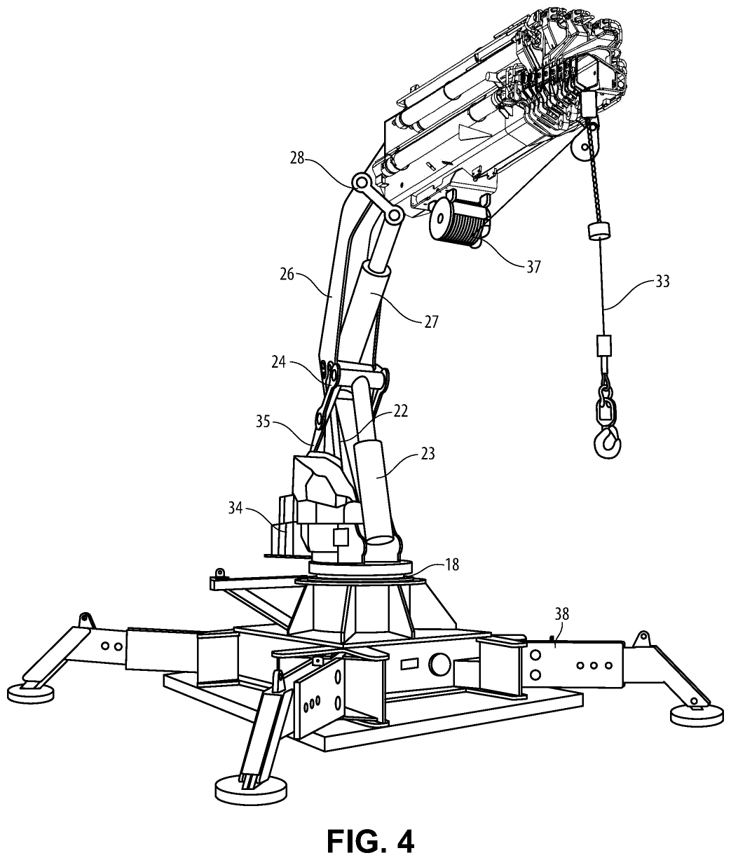

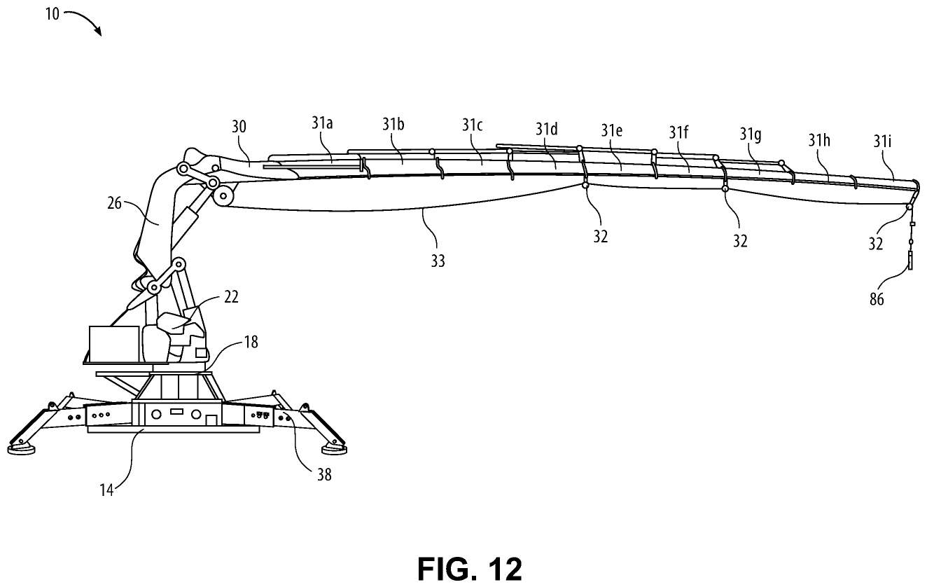

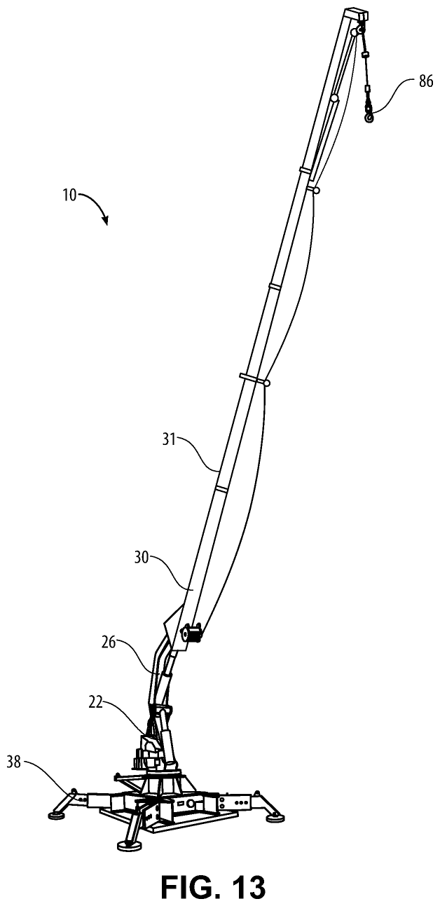

With specific reference to FIGS. 3 and 4, the slew column 22 includes a main hydraulic cylinder 23 that is operably coupled to a main joint 24. The main joint 24 is further coupled to the intermediate boom 26. The main hydraulic cylinder 23 is movable between a contracted and extended position to operably adjust a position of the intermediate boom 26. The intermediate boom 26 includes an intermediate hydraulic cylinder 27 that is coupled to an intermediate joint 28. The intermediate joint 28 is further coupled to the outer boom 30. The intermediate hydraulic cylinder 27 is movable between a contracted position and an extended position to operably adjust the position of the outer boom 30. The outer boom 30 includes a plurality of telescoping sections 31 (FIGS. 12 and 13), each of which are movable (e.g., by hydraulics, a cable, etc.) between a contracted and an extended position. A plurality of pulleys 32 are disposed along some (i.e., at least one) of the telescoping sections 31 and are configured to guide a cable 33. A portion of the cable 33 may be wound in a cable drum 37. The illustrated embodiment includes nine telescoping sections 31a-31i (FIG. 12), with the outermost telescoping section 31i being the crane tip. The crane tip may include one of the pulleys 32. In some embodiments, there are more than nine telescoping sections 31. In other embodiments, there are less than or greater than nine telescoping sections 31.

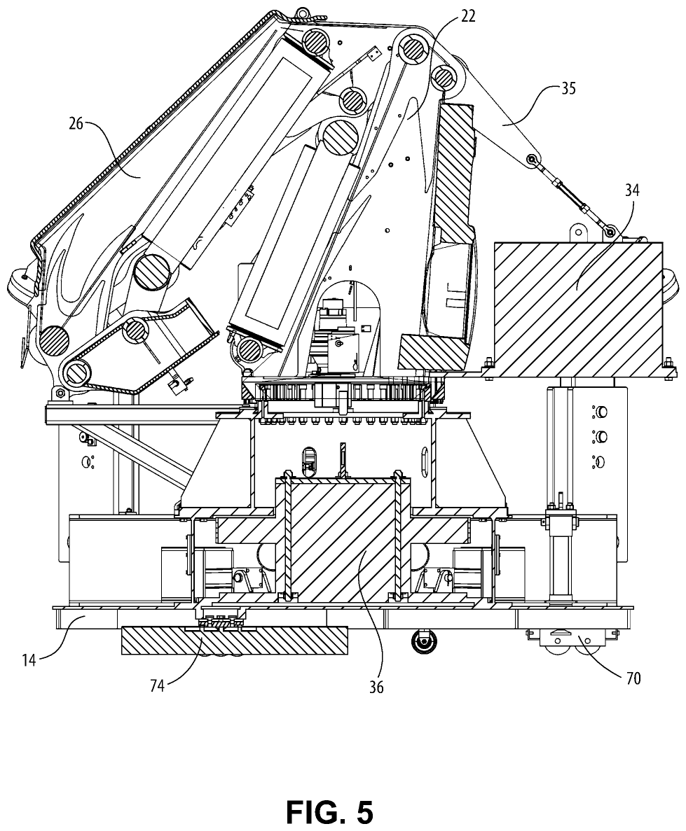

With continued reference to FIGS. 3 and 4, the counterweight 34 is further supported by a guy wire 35 that is connected to the main joint 24. The counterweight is cantilevered off the slew column 22 and rotates with the slew column 22. Thus, the counterweight 34 is always on the opposite side of the slew column 22 as the load lifted by the knuckle boom crane 10. In other words, the slew column 22 is always between the counterweight 34 and the load lifted. This allows the counterweight 34 to provide a moment upon the knuckle boom crane 10 that is in direct opposition to the moment upon the knuckle boom crane 10 created by the load. In this configuration, the counterweight 34 is always utilized to the maximum capability. The knuckle boom crane 10 further includes a central weight 36 (FIG. 5) configured to provide additional support to the knuckle boom crane 10. The central weight 36 lowers the center of gravity of the knuckle boom crane 10, allowing the knuckle boom crane 10 to withstand a greater moment created by the load.

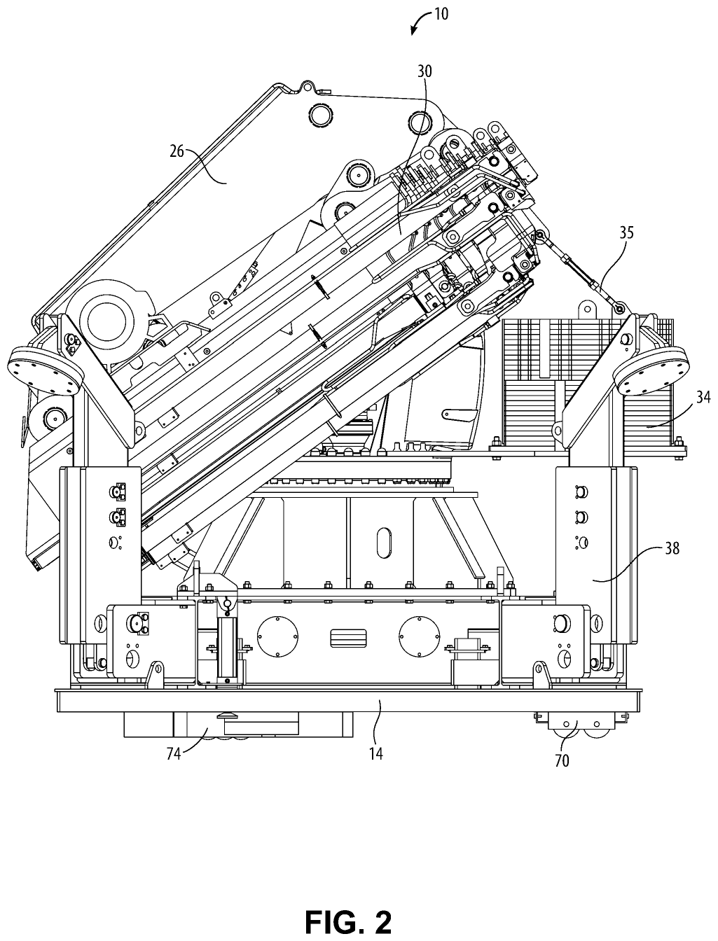

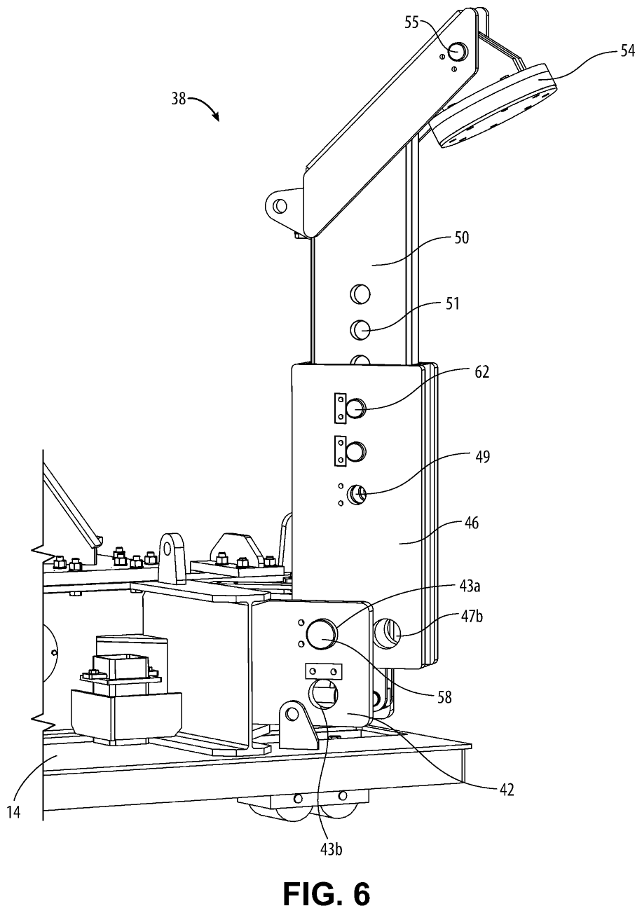

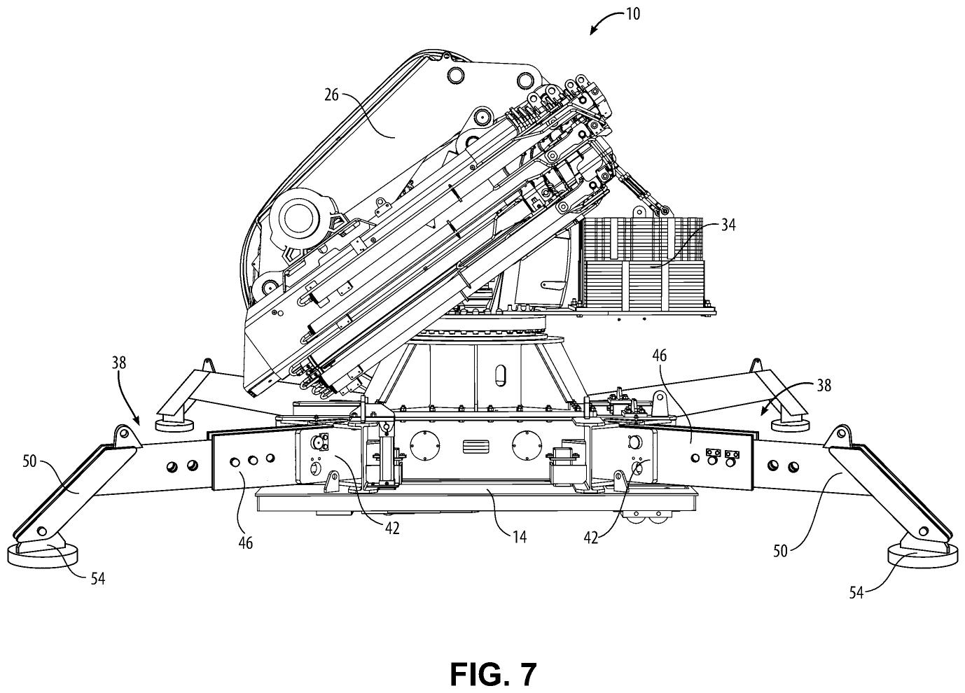

With reference to FIGS. 6 and 7, the outriggers 38 are pivotable between a stored position (FIG. 1) and a supporting position (FIG. 7). The supporting position can also be referred to as a deployed position. FIGS. 2, 5, and 8 also illustrate the outriggers 38 in the stored position, and FIGS. 3, 4, 12, and 13 also illustrate the outriggers 38 in the supporting position. In the stored position, the outriggers 38 are angled in an upright direction. More specifically, the outriggers 38 are oriented perpendicular to the base 14 when in the stored position. Each of the outriggers 38 includes an outrigger support 42 coupled (e.g., welded, bolted, etc.) to the base 14, a main body 46 pivotably coupled to the outrigger support 42, an extension post 50 received within and adjustable relative to the main body 46, and an outrigger pad 54 pivotably coupled to the extension post 50. The outrigger support 42 includes a plurality of pivot apertures 43 that are configured to align with a plurality of pivot apertures 47 on the main body 46. In the illustrated embodiment, the pivot apertures 43 on the outrigger support 42 include a top pivot aperture 43a and a bottom pivot aperture 43b, and the pivot apertures 47 on the main body 46 include a top pivot aperture (not shown) and a bottom pivot aperture 47b. In some embodiments, the pivot apertures 43, 47 on the outrigger support 42 and the main body 46 may respectively include more than two pivot apertures (e.g., three, four, etc.). The pivot apertures 43, 47 are similarly sized to receive pivot pins 58 to couple the main body 46 to the outrigger support 42. In the illustrated embodiment, one of the pivot pins 58 is inserted into the top pivot aperture (not shown) in the main body 46 and the top pivot aperture 43a in the outrigger support 42, such that the main body 46 is pivotable relative to the outrigger support 42 about the one of the pivot pins 58. A second of the pivot pins 58 can be inserted into the bottom pivot apertures 43b, 47b when the outrigger 38 is pivoted into the supporting position. In the illustrated embodiment, the pivot pins 58 are removably coupled (e.g., via bolts) to the outrigger support 42. In other embodiments, the pivot pins 58 may be housed within the pivot apertures 47 and biased away from the main body 46 by a biasing member (e.g., a spring). In these embodiments, as the main body 46 is received by the outrigger support 42, the outrigger support 42 contacts the pivot pins 58 and pushes the pivot pins 58 into the main body 46 against the bias of the biasing member. When the pivot pins 58 are aligned with the pivot apertures 43, the pivot pins 58 will be biased into the pivot apertures 43 to couple the main body 46 to the outrigger support 42.

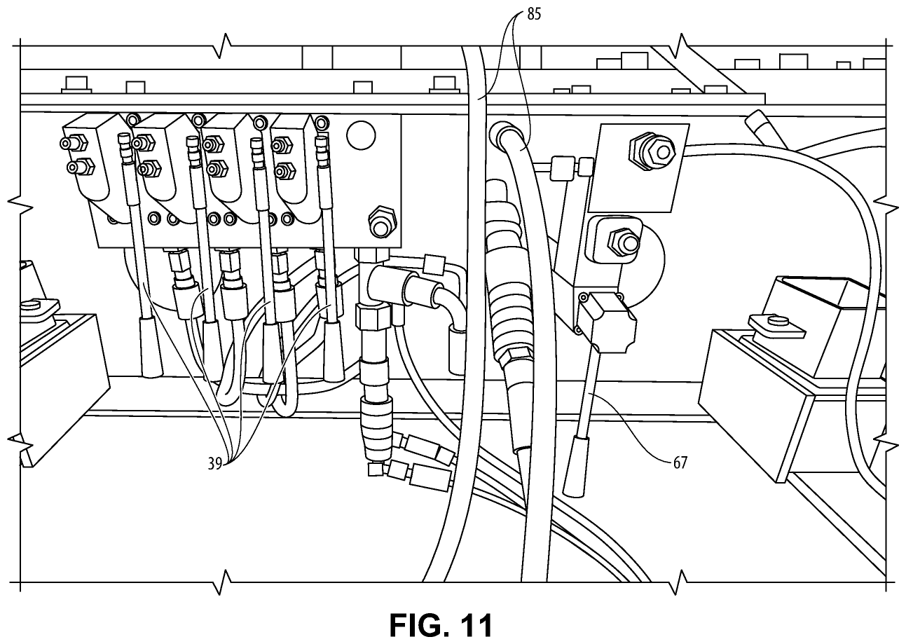

With continued reference to FIGS. 6 and 7, the extension post 50 may be adjusted between a plurality of positions relative to the main body 46. The extension post 50 includes a plurality of extension apertures 51, and the main body 46 includes a plurality of extension apertures 49. The extension apertures 49, 51 are similarly sized to receive extension pins 62 to couple the extension post 50 to the main body 46. The position of the extension post 50 may be adjusted to change the supporting capabilities of the outrigger 38. For example, the longer the length of the outrigger 38, the better the knuckle boom crane 10 can stabilize the load. Thus, to lift a maximum load, the extension post 50 may be adjusted to the longest position. The extension post 50 may also be adjusted based on ground space available. When the ground space is limited, the extension post 50 may be adjusted to the shortest position. In the illustrated embodiment, each of the outriggers 38 is adjusted by a respective outrigger control 39 (FIG. 11). The outrigger control 39 is operatively connected to a hydraulic unit to adjust the corresponding outrigger 38. Alternatively, in some embodiments, the outriggers 38 may be controlled in unison by a single outrigger control 39. The outrigger control 39 may be configured to pivot the main body 46 relative to the outrigger support 42, extend the extension post 50 relative to the main body 46, or both. In the illustrated embodiment, the extension apertures 49, 51 have a smaller diameter than the pivot apertures 43, 47, and the extension pins 62 have a smaller diameter than the pivot pins 58. In some embodiments, the extension apertures 49, 51 may have the same or a larger diameter than the pivot apertures 43, 47, and the extension pins 62 may have the same or a larger diameter than the pivot pins 58. The illustrated embodiment includes three extension apertures 49 on the main body 46 and five extension apertures 51 on the extension post 50, with two extension pins 62 disposed in the extension apertures 49, 51. In other embodiments, there may be a greater or fewer number of extension apertures 49, 51 and extension pins 62. The outrigger pad 54 is pivotably coupled to the extension post 50 via a pad pin 55. The outrigger pad 54 is configured to contact the ground surface and distribute the load to the ground surface. The illustrated outrigger pad 54 is circular, but may have a different shape (e.g., rectangular, triangular, etc.) in other embodiments. The illustrated knuckle boom crane 10 may fit through a ten-foot door when the outriggers 38 are in the stored position and the telescoping sections 31 of the outer boom 30 are in the retracted position. Stated another way, the knuckle boom crane 10 defines a width when the outriggers 38 are in the stored position. The width is less than ten (10) feet, such that the knuckle boom crane 10 can fit through a door with a width of ten (10) feet.

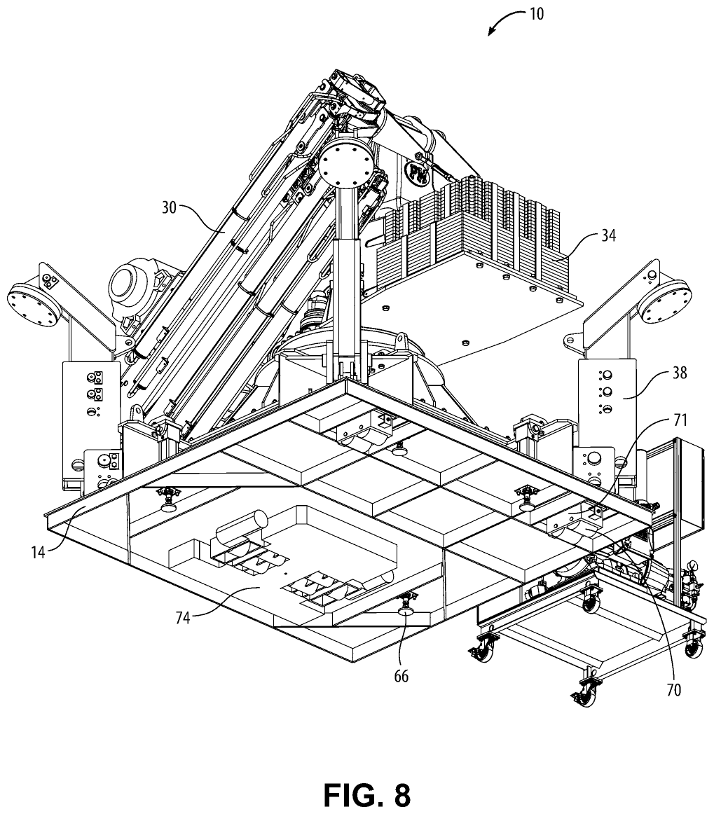

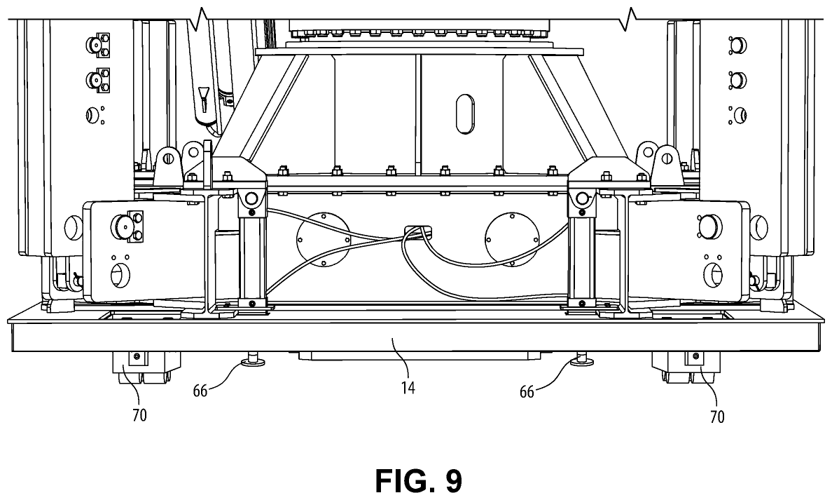

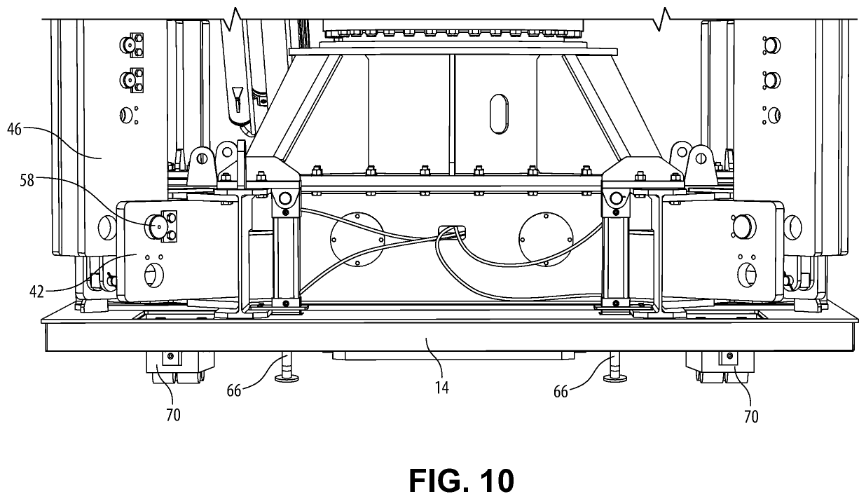

With reference to FIGS. 8-10, a plurality of hydraulic base lifts 66 are disposed on a bottom side of the base 14. The base lifts 66 are configured to move between a contracted position (FIG. 8) and an extended position (FIG. 10). The base lifts 66 are operable to support an entire weight of the knuckle boom crane 10 when the outriggers 38 are being adjusted (e.g., pivoted, extended, etc.). For example, when the outriggers 38 are in the stored position, the base lifts 66 may be adjusted to the extended position. In the extended position, the outriggers 38 may be extended to the desired length and pivoted to the supporting position. When the outriggers 38 are secured in the supporting position, the base lifts 66 may be adjusted to the contracted position, such that the entire weight of the knuckle boom crane 10 is supported by the outriggers 38. The base lifts 66 may then be adjusted back to the extended position, which allows the outriggers 38 to be adjusted back to the stored position. The base lifts 66 may then be adjusted back to the contracted position, such that the entire weight of the knuckle boom crane 10 is supported by front wheels 70 and a robotic driving unit 74. The base lifts 66 may move together in unison, such that they are controlled by a main base lift control 67 (FIG. 11). Alternatively, in some embodiments, the base lifts 66 may move independently, such that each of the base lifts 66 is controlled by a single control. In the illustrated embodiment, there are four base lifts 66 generally aligned in a trapezoidal arrangement. In other embodiments, there may be a different number of base lifts 66 in a different arrangement.

With reference to FIG. 8, front wheels 70 and a robotic driving unit 74 are disposed on the bottom side of the base 14 and are configured to drive the knuckle boom crane 10. In the illustrated embodiment, a housing 71 of the front wheels 70 is fixedly coupled to the bottom side of the base 14. In other embodiments, the housing 71 of the front wheels 70 may be pivotably coupled to the bottom side of the base 14. The robotic driving unit 74 is rotatably coupled to the bottom side of the base 14 and includes a motor and a plurality of wheels operationally coupled to the motor. The robotic driving unit 74 is electronically connected to an external controller, such that a user/operator may control the operation of the robotic driving unit 74 from a distance away from the knuckle boom crane 10. The robotic driving unit 74 controls the speed and the direction of movement of the knuckle boom crane 10.

With reference to FIGS. 1 and 11, the knuckle boom crane 10 is connected to a power pack 82. The power pack 82 includes a hydraulic power unit (HPU) 83 that is operably connected to the hydraulic units (e.g., the slew column 22, the intermediate boom 26, the outriggers 38, the base lifts 66) on the knuckle boom crane 10. The power pack 82 may also include a motor to power electrical components on the knuckle boom crane 10. In the illustrated embodiment, the power pack 82 is external to the knuckle boom crane 10. Stated another way, the power pack 82 is spaced apart from the knuckle boom crane 10. The power pack 82 includes a plurality of power pack wheels 84 configured to allow the power pack 82 to be manually moved along the ground surface by a user. In some embodiments, the power pack 82 may include a motor operably coupled to the power pack wheels 84, to allow the power pack 82 to be driven. In other embodiments, the power pack 82 may be coupled to the knuckle boom crane 10 by a cable (e.g., lanyard, lead, etc.), such that the power pack 82 is dragged behind the knuckle boom crane 10 as the knuckle boom crane 10 moves. In some embodiments, the power pack 82 is coupled to the base 14 of the knuckle boom crane 10.

With reference to FIG. 11, the power pack 82 is operably connected to the knuckle boom crane 10 by a plurality of cables 85. The cables 85 are removably coupled on a first end to the power pack 82 and removably coupled on a second end to the knuckle boom crane 10 adjacent the outrigger control 39 and the base lift control 67. Some of the cables 85 may be configured to guide hydraulic fluid between the power pack 82 and the knuckle boom crane 10. Others of the cables 85 may house wires configured to transmit electrical power or signals between the power pack 82 and the knuckle boom crane 10.

With reference to FIGS. 12 and 13, the telescoping sections 31 are all in the extended position, and the outriggers 38 are all in the supporting position. The cable 33 includes a hook 86 configured to attach to the load to lift the load.

Various features and advantages are set forth in the following claims.

What is claimed is:

1. A knuckle boom crane comprising:
a base with a top surface and a bottom surface;
a slew column rotatably coupled to the base;
a counterweight coupled to the slew column and configured to rotate with the slew column;
a telescoping boom pivotably coupled to the slew column;
a plurality of outriggers coupled to the top surface of the base and pivotable between a stored position and a supporting position; and
a robotic driving unit coupled to the bottom surface of the base and configured to drive the knuckle boom crane.

2. The knuckle boom crane of claim 1, wherein the plurality of outriggers supports a weight of the knuckle boom crane when the plurality of outriggers is in the supporting position.

3. The knuckle boom crane of claim 1, further comprising a plurality of base lifts coupled to the bottom surface and adjustable between a retracted position and an extended position.

4. The knuckle boom crane of claim 3, wherein the plurality of base lifts supports a weight of the knuckle boom crane when the plurality of base lifts is in the extended position.

5. The knuckle boom crane of claim 1, wherein the robotic driving unit supports a weight of the knuckle boom crane when the plurality of outriggers is in the stored position.

6. The knuckle boom crane of claim 1, wherein the knuckle boom crane has a width no greater than ten feet.

7. The knuckle boom crane of claim 1, wherein the knuckle boom crane is operably connected to a power pack that is spaced apart from the knuckle boom crane.

8. The knuckle boom crane of claim 7, wherein the power pack includes a hydraulic unit configured to pivot the plurality of outriggers between the stored position and the supporting position.

9. The knuckle boom crane of claim 1, wherein the robotic driving unit is electronically connected to an external controller.

10. The knuckle boom crane of claim 1, wherein the plurality of outriggers is angled in an upright direction when the plurality of outriggers is in the stored position.

11. The knuckle boom crane of claim 1, further comprising an intermediate boom pivotably coupled to the slew column wherein the telescoping boom is pivotably coupled to the intermediate boom.

12. The knuckle boom crane of claim 1, further comprising a slewing platform fixedly coupled to the top surface of the base wherein the slew column is rotatably coupled to the slewing platform.

13. A knuckle boom crane comprising:
a base with a top surface and a bottom surface;
a slew column rotatably coupled to the base;
a telescoping boom pivotably coupled to the slew column;
a plurality of outriggers coupled to the top surface of the base; and
a robotic driving unit rotatably coupled to the bottom surface of the base, the robotic driving unit connected to a controller configured to control operation of the robotic driving unit to drive the knuckle boom crane.

14. The knuckle boom crane of claim 13, wherein the knuckle boom crane is operably connected to a power pack spaced apart from the knuckle boom crane, and wherein the controller is positioned on the power pack.

15. The knuckle boom crane of claim 14, wherein the power pack includes a plurality of wheels configured to move the power pack along a surface with the knuckle boom crane.

16. The knuckle boom crane of claim 13, wherein the robotic driving unit supports a weight of the knuckle boom crane.

17. The knuckle boom crane of claim 16, further comprising a plurality of wheels coupled to the bottom surface of the base, wherein the robotic driving unit and the plurality of wheels support the weight of the knuckle boom crane.

18. The knuckle boom crane of claim 13, wherein the robotic driving unit includes a motor and a plurality of wheels operationally coupled to the motor.

19. The knuckle boom crane of claim 13, further comprising a counterweight coupled to the slew column and configured to rotate with the slew column.

20. The knuckle boom crane of claim 13, further comprising a plurality of base lifts coupled to the bottom surface of the base and adjustable between a retracted position and an extended position, wherein the plurality of base lifts supports a weight of the knuckle boom crane when the plurality of base lifts is in the extended position.
